(19) United States
(12) Patent Application Publication
(10) Pub. No.: US 2025/0115516 A1
(43) Pub. Date: Apr. 10, 2025

(54) CORROSION-RESISTANT AND/OR CLEANABLE COATED GLASS SUBSTRATE

(71) Applicants: Pilkington Group Limited, Lathom (GB); NIPPON SHEET GLASS CO., LTD., Tokyo (JP)

(72) Inventors: William ASPINALL, Lathom (GB); Anna Louise COLLEY, Rainhill, Prescot (GB); Charlie James PATRICKSON, Exeter (GB); Mitsuhiro KAWAZU, Tokyo (JP); Yoko WATANABE, Tokyo (JP)

(21) Appl. No.: 18/727,129

(22) PCT Filed: Jan. 12, 2023
(86) PCT No.: PCT/GB2023/050051

§ 371 Date: Jul. 8, 2024

(30) Foreign Application Priority Data
Jan. 13, 2022 (GB) 2200403.0

(51) Int. Cl. C03C 17/245; C03C 17/34

(52) U.S. Cl. CPC C03C 17/245; C03C 17/3417; C03C 17/3423; C03C 2217/213; C03C 2217/228; C03C 2217/78; C03C 2218/154

(57) ABSTRACT

A corrosion-resistant and/or cleanable coated glass substrates includes an outermost layer comprising from 0.5 to 20 atomic % cerium based on all components and to processes for producing corrosion-resistant and/or cleanable coated glass substrates including a step of sputtering a sputtering target comprising cerium to provide a layer comprising cerium oxide directly or indirectly on a first surface. The invention also provides the use of a layer comprising cerium oxide as a corrosion-resistant and/or cleanable coating on glass substrates, and to bath screens, shower screens and/or splash screens comprising corrosion-resistant and/or cleanable coated glass substrates.

The present invention relates to corrosion-resistant and/or cleanable coated glass substrates, to processes for producing corrosion-resistant and/or cleanable coated glass substrates, to the use of a layer comprising cerium oxide as a corrosion-resistant and/or cleanable coating on a glass substrates, and to bath screens, shower screens and/or splash screens comprising corrosion-resistant and/or cleanable coated glass substrates.

Coatings on substrates, especially glass substrates, may be used to modify the properties of the substrate. A number of methods may be used to deposit coatings upon glass substrates, such as liquid based methods including spin coating, dip coating, and spray coating, as well as chemical vapour deposition (CVD) and physical vapour deposition (PVD). Physical vapour deposition is also known as sputtering.

Glass in warm and moist or wet environments tends to become increasingly difficult to clean with time and becomes dull and hazy in appearance. This results from the relatively harsh conditions to which glass is subject in a moist or wet environment. Warm and moist environments can cause spotting, discoloration and corrosion to the surface of the glass. Hard water, soap scum and cleaning agents can worsen the problem. Corrosion of glass leads to irreversible damage to the glass surface.

Glass corrosion happens in two stages. The first stage is aqueous corrosion, caused by water in contact with the glass surface and involves alkali ion leaching from the glass. The second stage involves attack under even relatively mild alkaline conditions leading to dissolution of the glass surface. Cleaning agents used to clean glass surfaces and detergents and soaps may be mildly or strongly alkaline.

There have been attempts to provide surface treatments and/or coatings on glass which reduce or prevent glass corrosion.

JP H08208275 A discloses weather and water resistant glass articles having the glass surface etched with hydrofluoric acid to a depth of around 4 μm to 6 μm and then treated with an organic silazane system to render the surface water repellent.

EP 2647606 A relates to glass bath or shower screens intended to suffer from less limescale or corrosion by using silica layers deposited by sputtering. The document discloses that doping of the silica by greater than 8 atom % is necessary to prevent corrosion of glass.

EP 2559670 A discloses anti-corrosion coatings on glass made of alumina, titania, zirconia, or magnesium fluoride with controlled porosity.

WO 2013/003130 A discloses a protective film (for e.g. a shower glass door) of a sacrificial film containing diamond like carbon (DLC) and Zn, AlN_{y}, ZnNₓ or ZrO₂. The film is intended to undergo heat treatment before use.

US 2004/023080 A discloses a protective coating over a functional coating, the protective coating is sputtered and has two layers of Al₂O₃ containing SiO₂ and SiO₂ containing Al₂O₃.

US 20200079687 A1 discloses a coated substrate comprising: substrate, a soft coating comprising one or more layers deposited by physical vapor deposition provided on at least a part of at least one face of the substrate, and a sol-gel coating provided on at least a part of said face above the soft coating, wherein the sol-gel coating comprises a mixture of titanium oxide, zirconium oxide, silicon oxide and optionally bismuth oxide and/or cerium oxide in theoretical weight ratios of: titanium oxide TiO2/silicon oxide SiO2 ranging from 0.10 to 3, zirconium oxide ZrO2/silicon oxide SiO2 ranging from 0.10 to 3, bismuth oxide Bi2O3/silicon oxide SiO2 ranging from 0 to 0.03, and cerium oxide CeO2/silicon oxide SiO2 ranging from 0 to 0.03.

US 2018319701 A discloses a process to increase the mechanical and chemical resistance of a hydrolyzable network-forming silica gel coating on a surface of a substrate, the process comprising: applying a coating composition comprising a hydrolyzable, network-forming silica gel doped with a precursor of bismuth or cerium oxide to the surface.

In addition, it is desirable to increase the cleanability of glass and glazing products. Increased cleanability is associated with high water contact angle. Products or methods to improve cleanability include surface treatments to render the surface hydrophobic with, for example, sol gel formulations of hybrid organic-inorganic precursors, modified silanes with sol gel additives, or modified silanes which chemically cross-link after surface treatment. Other products include reactive silicone fluids to coat the surface with an easy-to-clean polymeric coating or polymeric resins to provide a low maintenance, non-stick surface. However, many of these treatments do not survive for the lifetime of the glass sheet.

Therefore, there still remains the need to provide corrosion-resistant glass substrates, especially those for humid environments, which provide long-lasting corrosion-resistant performance and cleanability performance.

It is an aim of the present invention to address the problems with known products or methods and to produce a glass substrate with no tendency or a reduced tendency to corrode and improved cleanability.

In particular, it is desirable to provide glass substrates for humid environments such as bath screens, shower screens, splash screens, viewing screens for car washes, aquatic viewing screens, fish tanks etc which provide the above mentioned benefits.

In a first aspect, the present invention provides a corrosion-resistant and/or cleanable coated glass substrate comprising:
a glass substrate with a first surface; and
a layer comprising cerium oxide directly or indirectly on the first surface, wherein:
the layer comprising cerium oxide is the outermost layer on the first surface; and
the layer comprising cerium oxide comprises from 0.5 to 20 atomic % cerium based on all components.

Preferably, the glass substrate is a soda-lime silica glass substrate. Alternatively, other glass compositions may be used, as borosilicate, aluminosilicate, boroaluminosilicate.

The layer comprising cerium oxide is the outermost layer on the first surface. When the layer comprising cerium oxide is the outermost layer on the first surface the layer comprising cerium oxide is directly exposed to the corrosion-resistant glass substrate's environment. It has been found that when the layer comprising cerium oxide is the outermost layer on the first surface, the layer comprising cerium oxide provides improved cleanability and durability and is highly effective at reducing or preventing corrosion of a glass surface. As such, the claimed corrosion-resistant coated glass substrate is particularly suitable for use in a humid environment such as bath screens, shower screens, splash screens, viewing screens for car washes, aquatic viewing screens, fish tanks etc.

Preferably, the layer comprising cerium oxide is homogenous in cerium. A layer comprising cerium oxide that is homogenous in cerium comprises cerium atoms which are dispersed to a homogenous extent across the coating layer. Preferably, the cerium atoms are within and constitute an amorphous or semi-amorphous coating layer applied to the first surface, such as that which is provided by sputtering. Preferably, the cerium atoms are not within nanoparticles, and preferably the layer comprising cerium oxide does not comprise particles and/or nanoparticles.

Advantageously, the coated glass is corrosion resistant as indicated by a relatively low increase in haze after weathering. Weathering may be accelerated by high humidity, heat or hot/cold cycles and for testing purposes weathering may be simulated by maintaining the glass at an elevated temperature in high humidity for predetermined periods. Usually, the measured haze (using e.g. a haze meter) of the coated glass will be 25% or below, preferably 20% or below, more preferably 15% or below, even more preferably 10% and most preferably 5% or below after 50 days at 98% relative humidity and 60° C. Preferably, the corrosion-resistant coated glass substrate exhibits a haze increase of 55% or below, more preferably 35% or below and most preferably 24% or below after 50 days at 98% relative humidity and 60° C. The haze increase may be calculated by comparing the measured haze before and after weathering.

Usually, the layer comprising cerium oxide may have a thickness of 1 nm or higher, preferably 10 nm or higher, more preferably 20 nm or higher and most preferably 30 nm or higher. Coatings that are too thin may not be sufficiently durable or effective. It is preferred that the layer comprising cerium oxide has a thickness 500 nm or lower, preferably 250 nm or lower, more preferably 100 nm or lower and most preferably 50 nm or lower. Coatings that are too thick may be subject to cracking during a heat treatment or toughening process, and may be uneconomical to produce.

Thus, preferably, the layer comprising cerium oxide has a thickness in the range 1 nm to 500 nm, preferably 5 to 250 nm, more preferably 10 to 100 nm. Such thicknesses are advantageous because they provide a good balance between corrosion protection, durability and economy of production.

The layer comprising cerium oxide will usually have a refractive index in the range 2.28 to 2.44.

In some embodiments it is preferred that the layer comprising cerium oxide is the only layer on the first surface. However, in alternative embodiments it is preferred that an underlayer is provided between the layer comprising cerium oxide and the first surface. Preferably, the underlayer comprises silicon oxide. Such an underlayer may improve the adhesion and durability of the layer comprising cerium oxide. Preferably, the underlayer comprising silicon oxide is directly on the first surface. This further improves adhesion and durability of coatings upon the substrate.

In one preferred embodiment the underlayer comprising silicon oxide is directly on the first surface, and the layer comprising cerium oxide is directly on the underlayer comprising silicon oxide. This arrangement of layers provides excellent adhesion and durability of coating layers in an efficient manner.

Preferably, the layer comprising cerium oxide comprises from 1 to 10 atomic % cerium based on all components, preferably from 2 to 8 atomic % cerium based on all components. Such a range is shown to provide excellent corrosion resistance and cleanability.

Preferably, the layer comprising cerium oxide is substoichiometric in oxygen.

Preferably, the layer comprising cerium oxide further comprises titanium, preferably the layer comprising cerium oxide comprises from 50 to 95 atomic % titanium based on titanium and cerium, more preferably the layer comprising cerium oxide comprises from 70 to 90 atomic % titanium based on titanium and cerium, even more preferably the layer comprising cerium oxide comprises from 75 to 85 atomic % titanium based on titanium and cerium.

Preferably, the layer comprising cerium oxide comprises less than 10 atomic % silicon based on all components, preferably the layer comprising cerium comprises less than 1 atomic % silicon based on all components, more preferably the layer comprising cerium is essentially free of silicon.

Preferably, the layer comprising cerium oxide comprises less than 10 atomic % aluminium based on all components, preferably the layer comprising cerium comprises less than 1 atomic % aluminium based on all components, more preferably the layer comprising cerium is essentially free of aluminium.

Preferably, the coated glass substrate exhibits a water contact angle of greater than 300, preferably greater than 50°, even more preferably greater than 60°. Such water contact angles are associated with good cleanability. Therefore, according to the present specification a substrate is cleanable when it exhibits a water contact angle of greater than 30°, preferably greater than 50°, even more preferably greater than 60°

It is preferred that the substrate is toughened glass. Toughened glass substrates are particularly advantageous because they enhance user safety in e.g. shower or bath screens and other applications of the present invention. In some cases, the use of toughened glass may be required to meet legislation. It is preferred, for reasons of safety that the substrate is toughened. If the substrate has at least one hole, drilled through the substrate, the substrate may be toughened after the hole(s) are drilled.

However, the substrate may be untoughened float glass, and the coated glass substrate may then be supplied to a manufacturer to be cut and/or toughened as required. Where the substrate is untoughened float glass the coated glass substrate may be referred to as “heat-treatable” or “toughenable”.

The substrate may be adapted to hold fixings to fix the substrate in position for use. The substrate may be adapted to hold fixings by having at least one hole (for example one hole, two holes, three holes, four holes or more than four holes) drilled through the substrate.

The substrate is preferably edge-worked.

According to a second aspect of the present invention, there is provided a process for producing a corrosion-resistant and/or cleanable coated glass substrate, preferably a corrosion-resistant coated glass substrate according to the first aspect of the invention, the process comprising:
providing a glass substrate with a first surface;
providing a sputtering target comprising cerium; and
sputtering the sputtering target comprising cerium to provide a layer comprising cerium oxide directly or indirectly on the first surface.

Such a process provides a corrosion-resistant coated glass substrate.

Preferably, the glass substrate is a soda-lime silica glass substrate. Alternatively, other glass compositions may be used, as borosilicate, aluminosilicate, boroaluminosilicate.

Preferably, the sputtering target comprises titanium, preferably from 50 to 95 atomic % titanium based on titanium and cerium, more preferably the sputtering target comprises from 70 to 90 atomic % titanium based on titanium and cerium, even more preferably the sputtering target comprises from 75 to 85 atomic % titanium based on titanium and cerium. Inclusion of titanium in the sputtering target may improve the conductivity of the sputtering target, and thereby improve the rate of the sputtering process.

Preferably, the step of sputtering the sputtering target is carried out in atmosphere with less than 10 volume % oxygen, preferably less than 5 volume % oxygen, even more preferably less than 1 volume % oxygen. The skilled person may evaluate the sputtering atmosphere based on the flow rates of the sputtering atmosphere gases. Preferably, the step of sputtering the sputtering target is carried out in an atmosphere comprising a noble gas, preferably the noble gas is argon or krypton. Preferably, the sputtering atmosphere is greater than 50 volume % noble gas, preferably argon, even more preferably greater than 90 volume % noble gas, preferably argon.

When the sputtering step is carried out in an atmosphere that is low in oxygen the oxygen atoms to be supplied to the coating may be supplied from the target. A sputtering target comprising a significant proportion of oxygen may be considered “ceramic”. As such, preferably the sputtering target is a ceramic sputtering target.

Preferably, the sputtering step is a plasma sputtering step. When the plasma sputtering method is used, films of uniform quality can be obtained and adhesion force of the film is high. In some cases a large scale of target can be used, allowing films to be produced on large glass sizes. The plasma sputtering methods include DC sputtering, RF sputtering, magnetron sputtering, and reactive sputtering. Preferably, the layer comprising cerium oxide is produced by magnetron sputtering. First, argon gas and optionally oxygen gas is introduced into a vacuum chamber at an adequate amount that a voltage can be applied to a cathode where a target material is installed. At this time, electrons released from the cathode collide with gas atoms of Ar gas, thereby ionizing Ar gas atoms to Ar⁺ ions. At that time, electrons are released with argon being excited and thus energy is emitted. Therefore, glow discharge is created. Due to the glow discharge, plasma is formed where ions and electrons coexist. Ar⁺ ions in the plasma accelerate towards the cathode target due to the large potential difference and collide with the surface of the target. As a result, target atoms are displaced and are expelled towards the substrate, forming the coating layer.

Preferably, the process further comprising the step of cleaning the surface before the step of sputtering the sputtering target. Such a step may improve the durability and/or appearance of the coating layer. Preferably cleaning the surface comprises one or more of: abrasion with ceria; washing with alkaline aqueous solution; deionised water rinse; and plasma treatment. In addition or alternatively other cleaning methods may be employed such as those known to the skilled person.

Preferably, the sputtering target is a cylindrical sputtering target. Cylindrical sputtering targets may be employed to improve the homogeneity of the produced coating layer and/or to provide high quality coatings in a repeatable manner.

The substrate may be toughened before application of the layer comprising cerium oxide. However, it is most preferred that the substrate is toughened by a heat treatment step after application of the layer comprising cerium oxide. As such, preferably the process further comprises a step of heat treating the soda lime silica glass substrate after the step of sputtering the sputtering target, preferably wherein the step of heat treating the soda lime silica glass substrate comprises heating the soda lime silica glass substrate to at least 600° C. for at least 5 minutes.

The inventors have discovered that the layer comprising cerium oxide produced by the present method is suitable for such a heat-treatment, as it does not undergo significant damage as indicated by minimal changes in transparency, haze and durability following heat treatment. As such, the layer comprising cerium oxide is considered “heat-treatable”. This is highly beneficial, as the coating may be applied at scale by the glass producer, and then may be cut and toughened as required by manufacturers of bath screens, shower screens and the like. Therefore, a high quality corrosion resistant coating may be provided to manufacturers that does not require changes to manufacturer processing steps.

As described above, in some embodiments the corrosion-resistant coated glass substrate may comprise an underlayer between the layer comprising cerium oxide and the first surface, and preferably the underlayer comprises silicon oxide. Where the coated glass substrate comprises an underlayer this may be formed by a coating method that is the same as, or different from, the coating method of the layer comprising cerium oxide.

In one embodiment the underlayer, preferably a silicon oxide underlayer, is produced by a sputtering method, and the layer comprising cerium oxide is produced by a sputtering method. This allows a high quality product to be obtained. The skilled person is aware of methods of providing layers such as underlayers via sputtering.

In an alternative embodiment the underlayer, preferably a silicon oxide underlayer, is produced by a chemical vapour deposition method, preferably an “online” chemical vapour deposition method during the float process, and the layer comprising cerium oxide is produced by a sputtering method. This may allow for increased production speed of product. Deposition of silicon oxide layers using chemical vapour deposition, also known as pyrolytic deposition, may be carried out as disclosed in US 2018118613 A1, incorporated herein by reference. Usually, pyrolytically depositing the underlayer comprises contacting the surface of the substrate with a precursor mixture comprising a source of silicon, a source of oxygen and optionally a radical scavenger. The source of silicon may comprise an oxygenated silicon compound for example a silicon alkoxide (e.g. tetraethylorthosilicate, TEOS), and/or a silicon halide (e.g. silicon chloride). Preferably, however, the source of silicon comprises a silane, more preferably monosilane, SiH₄. The pyrolytic deposition of silicon oxide may be advantageously carried out in conjunction with the manufacture of the glass substrate in the well-known float glass manufacturing process. It was found that a silicon oxide underlayer produced by chemical vapour deposition improved the durability of the coating compared to a sputtered silicon oxide underlayer. In addition, the measured water contact angle of the coating comprising cerium oxide was improved with an underlayer comprising silicon oxide produced by chemical vapour deposition as compared to a coating comprising cerium oxide with an underlayer comprising silicon oxide produced by sputtering.

In some embodiments the underlayer may be applied to the first surface by application of a liquid coating precursor, preferably a liquid coating precursor comprising a silazane, preferably a polysilazane, or an orthosilicate, preferably tetraethylorthosilicate (TEOS). Methods of producing an underlayer from a liquid coating precursor comprising polysilazane are disclosed for example in WO 2017187173 A1, incorporated herein by reference. The method by which the liquid coating precursor is applied to the surface is not normally critical and a variety of techniques may be used. Contacting the surface with the coating composition may, for example, comprise a method selected from dip coating, spin coating, roller coating, spray coating, air atomisation spraying, ultrasonic spraying, and/or slot-die coating. Preferably, the liquid coating precursor is cured following application to provide a coating.

According to a third aspect of the present invention there is provided the use of a layer comprising cerium oxide as a corrosion-resistant and/or cleanable coating on a glass substrate, wherein:
the glass substrate comprises a first surface;
the layer comprising cerium oxide is directly or indirectly on the first surface;
the layer comprising cerium oxide is the outermost layer on the first surface; and
the layer comprising cerium oxide comprises from 0.5 to 20 atomic % cerium based on all components.

Preferably, the glass substrate is a soda-lime silica glass substrate. Alternatively, other glass compositions may be used, as borosilicate, aluminosilicate, boroaluminosilicate.

According to a fourth aspect of the present invention there is provided a bath screen, a shower screen and/or splash screen comprising a corrosion-resistant and/or cleanable coated glass substrate according to the first aspect, or manufactured according to the second aspect.

Preferably, the bath and/or shower screen further comprises fixings to fix the bath screen and/or a shower screen in position for use. Usually, the fixings will comprise adhesive portions or mechanical attachment portions to attach the fixings to the splash screen. Such fixings may include hinge fixings. The fixings may be attached to the splash screen through adhesion (e.g. adhesives pads attached to at least one surface of the splash screen and to the fixings) and/or through mechanical attachment, (e.g. bolts) extending through or attached to holes in the splash screen. Such holes may be drilled holes.

The skilled person will appreciate that optional or preferable features of aspects of the present invention may be applied to other aspects according to their needs and requirements.

The present invention will now be described by way of example only, and with reference to, the accompanying drawings, in which:

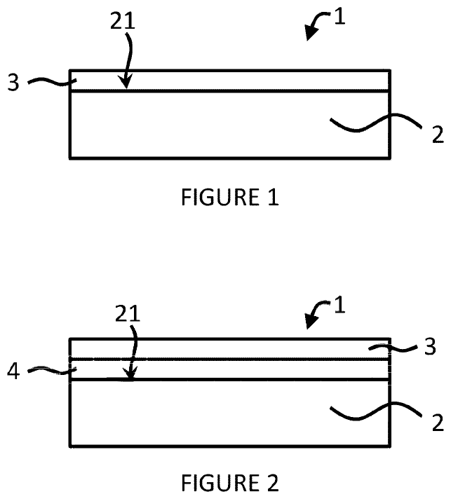

FIG. 1 illustrates schematically a coated substrate according to an embodiment of the present invention;

FIG. 2 illustrates schematically a coated substrate according to an embodiment of the present invention, comprising an underlayer.

FIG. 1 illustrates schematically a coated glass substrate 1 comprising: a substrate of soda lime silica glass 2 with a first surface 21; and a layer 3 comprising cerium oxide directly on the first surface 21, wherein the layer 3 comprising cerium oxide is the outermost layer on the first surface 21.

FIG. 2 illustrates schematically a coated glass substrate 1 comprising: a substrate of soda lime silica glass 2 with a first surface 21; and a layer 3 comprising cerium oxide indirectly on the first surface 21, wherein the layer 3 comprising cerium oxide is the outermost layer on the first surface 21, further comprising an underlayer 4 between the layer comprising cerium oxide 3 and the first surface 21 and wherein the underlayer 4 is directly on the first surface 21. Preferably the underlayer 4 comprises silicon oxide.

The invention is further illustrated, but not limited, by the following examples.

Examples according to the invention were prepared by sputtering a rotatable ceramic target comprising 65 weight % TiO₂ and 35 weight % CeO₂ (corresponding to 80.0 atomic % titanium and 20.0 atomic % cerium based on cerium and titanium, and corresponding to 26.7 atomic % titanium, 6.7 atomic % cerium and 66.7 atomic % oxygen based on all components) with length 23 inches and diameter 5.914 inches. A layer comprising cerium, titanium and oxygen CeTiOₓ was formed.

Examples 1 to 3 were prepared by sputtering the layer comprising CeTiOₓ directly onto a soda-lime silica glass substrate, while examples 4 to 6 were prepared by sputtering the layer comprising CeTiOₓ onto an underlayer comprising silicon oxide. The underlayer comprising silicon oxide was produced in these examples using chemical vapour deposition with a thickness of 20 to 30 nm.

Where examples and comparative examples were submitted to heat treatment, this constituted a temperature of 650° C. for 5 minutes.

### CHARACTERISATION OF EXAMPLES

The coated substrates were tested for optical properties (according to ISO 9050) water contact angle (50 μl deionized water droplet) and resistance to humidity-induced corrosion.

Table 1 depicts the average water contact angle (n=5) of 10×10 cm samples measured after deposition (AD), following heat treatment and 2 weeks aging in atmosphere (HT 2 weeks) and following heat treatment and 3 weeks aging in atmosphere (HT 3 weeks). Water contact angle was measured with deionised water using a FTA200 with FTA32 software, both available from First Ten Angstroms, Newark, CA, USA.

TABLE 1

| | | Average Water Contact Angle | | |
|---|---|---|---|---|
| Sample | Coating | AD | HT 2 weeks | HT 3 weeks |
| 1 | CeTiOₓ (10 nm) | 60.79 | 47.76 | 50.68 |
| 2 | CeTiOₓ (25 nm) | 60.34 | 18.23 | 25.78 |
| 3 | CeTiOₓ (50 nm) | 62.06 | 22.66 | 37.10 |
| 4 | SiO₂, CeTiOₓ (10 nm) | 59.47 | 24.62 | 35.56 |
| 5 | SiO₂, CeTiOₓ (25 nm) | 61.82 | 39.27 | 46.94 |
| 6 | SiO₂, CeTiOₓ (50 nm) | 64.32 | 45.86 | 50.39 |

From Table 1 it can be seen that substrates with surprisingly high water contact angles of greater than 60° may be obtained with a CeTiOₓ, compared to untreated glass which has a water contact angle of 25°. A high water contact angle is associated with improved cleanability. As such, a cleanable substrate is produced by the application of the inventive coating.

Indeed, high water contact angles may be obtained with a coating of only 10 nm thickness, and that this is surprisingly long lasting. Meanwhile, a coating with a surprisingly high water contact angle may be obtained with a CeTiOₓ coating of 50 nm, and the aging performance of such a coating is markedly improved by the presence of a silicon oxide underlayer. Similarly, the aging performance of a CeTiOₓ coating of 25 nm is improved by the presence of a silicon oxide underlayer.

As such, in embodiments where a silicon oxide underlayer is desired, it is desirable that the thickness of a CeTiOₓ layer is greater than 10 nm, preferably 25 nm or greater, more preferably 50 nm or greater, such as from greater than 10 nm to 500 nm, preferably 25 nm to 250 nm, more preferably from 50 nm to 100 nm. It was noticed that water contact angle increases with aging to a stable value.

Examples and comparative examples were submitted to alkali corrosion testing, wherein heat treated samples were immersed in 1M NaOH at 23° C. for 2 hours. The change in haze was assessed (BYK Gardner Haze-gard plus) according to ASTM D1003 as depicted in Table 2, and the change in transmittance was assessed as depicted in Table 3.

TABLE 2

| | | Haze, 2 Hours in 1M NaOH at 23° C. | | |
|---|---|---|---|---|
| Sample | Coating | Initial | 2 Hours | Delta |
| 1 | CeTiOₓ (10 nm) | 0.1 | 0.09 | −0.01 |
| 2 | CeTiOₓ (25 nm) | 0.15 | 0.14 | −0.01 |
| 3 | CeTiOₓ (50 nm) | 0.26 | 0.24 | −0.02 |
| 4 | SiO₂, CeTiOₓ (10 nm) | 0.17 | 0.12 | −0.05 |
| 5 | SiO₂, CeTiOₓ (25 nm) | 0.21 | 0.18 | −0.03 |
| 6 | SiO₂, CeTiOₓ (50 nm) | 0.34 | 0.26 | −0.08 |

TABLE 3

| | | Transmittance, 2 Hours in 1M | | |
|---|---|---|---|---|
| | | NaOH at 23° C. | | |
| Sample | Coating | Initial | 2 Hours | Delta |
| 1 | CeTiOₓ (10 nm) | 89.5 | 89.5 | 0 |
| 2 | CeTiOₓ (25 nm) | 79.8 | 80 | 0.2 |
| 3 | CeTiOₓ (50 nm) | 68.1 | 68.1 | 0 |
| 4 | SiO₂, CeTiOₓ (10 nm) | 91.1 | 91.1 | 0 |
| 5 | SiO₂, CeTiOₓ (25 nm) | 80.9 | 81.2 | 0.3 |
| 6 | SiO₂, CeTiOₓ (50 nm) | 67.1 | 67.1 | 0 |

Table 2 shows that all measured samples exhibited extremely low haze both initially and after alkali corrosion testing, indicating excellent corrosion resistance by CeTiOₓ coatings. Similarly, Table 3 shows that transmittance is reduced by increasing thickness of CeTiOₓ coating, but is increased, or only slightly reduced, by the presence of a silicon oxide underlayer. The change in transmittance caused by alkali corrosion testing is negligible.

Examples and comparative examples were submitted to acid corrosion testing, wherein heat treated samples were immersed in 1M HCl at 23° C. for 2 hours. The change in haze was assessed (BYK Gardner Haze-gard plus) according to ASTM D1003 as depicted in Table 2, and the change in transmittance was assessed as depicted in Table 3.

TABLE 4

| | | Haze, 2 Hours in 1M HCl at 23° C. | | |
|---|---|---|---|---|
| Sample | Coating | Initial | 2 Hours | Delta |
| 1 | CeTiOₓ (10 nm) | 0.1 | 0.11 | 0.01 |
| 2 | CeTiOₓ (25 nm) | 0.14 | 0.12 | −0.02 |
| 3 | CeTiOₓ (50 nm) | 0.26 | 0.24 | −0.02 |
| 4 | SiO₂, CeTiOₓ (10 nm) | 0.15 | 0.12 | −0.03 |
| 5 | SiO₂, CeTiOₓ (25 nm) | 0.17 | 0.18 | 0.01 |
| 6 | SiO₂, CeTiOₓ (50 nm) | 0.23 | 0.21 | −0.02 |

Table 4 shows that all measured samples exhibited extremely low haze both initially and after acid corrosion testing, indicating excellent corrosion resistance by CeTiOₓ coatings.

TABLE 5

| | | Transmittance, 2 Hours in 1M | | |
|---|---|---|---|---|
| | | HCl at 23° C. | | |
| Sample | Coating | Initial | 2 Hours | Delta |
| 1 | CeTiOₓ (10 nm) | 89.5 | 89.7 | 0.2 |
| 2 | CeTiOₓ (25 nm) | 80.1 | 80.4 | 0.3 |
| 3 | CeTiOₓ (50 nm) | 68 | 68.2 | 0.2 |
| 4 | SiO₂, CeTiOₓ (10 nm) | 91.1 | 91.3 | 0.2 |
| 5 | SiO₂, CeTiOₓ (25 nm) | 80.9 | 81.3 | 0.4 |
| 6 | SiO₂, CeTiOₓ (50 nm) | 67.2 | 67.3 | 0.1 |

Table 5 shows that the change in transmittance caused by acid corrosion testing is negligible.

As such, CeTiOₓ coatings may be used to produce heat treated coated glass substrates with excellent cleanability and excellent corrosion resistance. Furthermore, the coated glass substrate responds very well to heat treatment, as such there is provided a heat treatable coated glass substrate which may be heat treated to produce a heat treated coated glass substrate with excellent cleanability and excellent corrosion resistance.

1.-24. (canceled)

25. A corrosion-resistant and/or cleanable coated glass substrate comprising:
a glass substrate with a first surface; and
a layer comprising cerium oxide directly or indirectly on the first surface, wherein:
the layer comprising cerium oxide is the outermost layer on the first surface; and
the layer comprising cerium oxide comprises from 0.5 to 20 atomic % cerium based on all components.

26. The coated glass substrate according to claim 25, wherein the coated glass substrate exhibits a haze increase of 1% or below after 2 hours immersed in 1M NaOH or 1M HCl at 23° C.

27. The coated glass substrate according to claim 25, wherein the layer comprising cerium oxide has a thickness of from 1 nm to 500 nm, preferably from 5 nm to 250 nm, more preferably from 10 nm to 100 nm.

28. The coated glass substrate according to claim 25, wherein the layer comprising cerium oxide has a refractive index in the range 2.28 to 2.44.

29. The coated glass substrate according to claim 25, wherein the layer comprising cerium oxide is the only layer on the first surface.

30. The coated glass substrate according to claim 25, further comprising an underlayer between the layer comprising cerium oxide and the first surface.

31. The coated glass substrate according to claim 30, wherein the underlayer comprises silicon oxide, preferably the underlayer comprising silicon oxide is directly on the first surface, more preferably the underlayer comprising silicon oxide is directly on the first surface and the layer comprising cerium oxide is directly on the underlayer.

32. The coated glass substrate according to claim 25, wherein the layer comprising cerium oxide comprises from 1 to 10 atomic % cerium based on all components, preferably from 2 to 8 atomic % cerium based on all components.

33. The coated glass substrate according to claim 25, wherein the layer comprising cerium oxide is substoichiometric in oxygen.

34. The coated glass substrate according to claim 25, wherein the layer comprising cerium oxide further comprises titanium, preferably the layer comprising cerium oxide comprises from 50 to 95 atomic % titanium based on titanium and cerium, more preferably the layer comprising cerium oxide comprises from 70 to 90 atomic % titanium based on titanium and cerium, even more preferably the layer comprising cerium oxide comprising from 75 to 85 atomic % titanium based on titanium and cerium.

35. The coated glass substrate according to claim 25, wherein the layer comprising cerium oxide comprises less than 10 atomic % silicon based on all components, preferably the layer comprising cerium comprises less than 1 atomic % silicon based on all components, more preferably the layer comprising cerium is essentially free of silicon.

36. The coated glass substrate according to claim 25, wherein the layer comprising cerium oxide comprises less than 10 atomic % aluminium based on all components, preferably the layer comprising cerium comprises less than 1 atomic % aluminium based on all components, more preferably the layer comprising cerium is essentially free of aluminium.

37. The coated glass substrate according to claim 25, wherein the coated glass substrate exhibits a water contact angle of greater than 30°, preferably greater than 50°, even more preferably greater than 60°.

38. The coated glass substrate according to claim 25, wherein the substrate is toughened glass.

39. A process for producing a corrosion-resistant and/or cleanable coated glass substrate, the process comprising:
providing a glass substrate with a first surface;
providing a sputtering target comprising cerium; and
sputtering the sputtering target comprising cerium to provide a layer comprising cerium oxide directly or indirectly on the first surface.

40. The process according to claim 39, wherein the sputtering target comprises titanium, preferably from 50 to 95 atomic % titanium based on titanium and cerium, more preferably the sputtering target comprises from 70 to 90 atomic % titanium based on titanium and cerium, even more preferably the sputtering target comprises from 75 to 85 atomic % titanium based on titanium and cerium.

41. The process according to claim 39, wherein the step of sputtering the sputtering target is carried out in an atmosphere comprising a noble gas, preferably the noble gas is argon or krypton.

42. The process according to claim 39, further comprising cleaning the surface before the step of sputtering the sputtering target, preferably cleaning the surface comprises one or more of: abrasion with ceria; washing with alkaline aqueous solution; deionised water rinse; and plasma treatment.

43. The process according to claim 39, wherein the sputtering target is a cylindrical sputtering target.

44. The process according to claim 39, further comprising the step of heat treating the soda lime silica glass substrate after the step of sputtering the sputtering target, preferably wherein the step of heat treating the soda lime silica glass substrate comprises heating the soda lime silica glass substrate to at least 600° C. for at least 5 minutes.

45. The process according to claim 39, further comprising the step of applying an underlayer to the first surface prior to the step of sputtering the sputtering target, preferably the step of applying the underlayer comprises depositing a layer comprising silica by chemical vapour deposition, physical vapour deposition, or liquid deposition, preferably by chemical vapour deposition.

46. A bath screen, a shower screen and/or splash screen comprising a corrosion-resistant and/or cleanable coated glass substrate as claimed in claim 25.

47. A bath screen, shower screen and/or splash screen as claimed in claim 46, further comprising fixings to fix the bath screen and/or a shower screen in position for use, preferably the fixings comprise adhesive portions or mechanical attachment portions to attach the fixings to the splash screen.
